(19) United States
(12) Patent Application Publication
(10) Pub. No.: US 2010/0055242 A1
(43) Pub. Date: Mar. 4, 2010

(54) METHOD FOR PREPARING SOFT VEGETABLE MATERIAL

(75) Inventors: Koji Ueshimo, Hiroshima (JP); Kenji Baba, Hiroshima (JP); Tsuneo Takei, Hiroshima (JP); Takeshi Ishikawa, Hiroshima (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Mishima Foods Co., Ltd., Hiroshima-shi, Hiroshima (JP)

(21) Appl. No.: 12/439,827

(22) PCT Filed: Sep. 4, 2007
(86) PCT No.: PCT/JP2007/067172

§ 371 Date: Mar. 4, 2009

(30) Foreign Application Priority Data
Sep. 4, 2006 (JP) 2006-239094

(51) Int. Cl. A23L 1/212; A23B 7/00

(52) U.S. Cl. 426/50; 426/52; 426/615

(57) ABSTRACT

The present invention provides a method for preparing a soft vegetable material which is suitably used for the production of a food or a meal for, in particular, the aged persons and which holds the shape of a particular ingredient of the food. The method comprises the steps of: (1) freezing a vegetable material and then thawing the frozen vegetable material to thus form a thawed vegetable material; (2) immersing the thawed vegetable material in a dispersion containing a pectin-decomposition enzyme or a cellulose-decomposition enzyme under reduced pressure; and (3) subjecting the vegetable material, which has been immersed in the dispersion and then thawed, to a heat-treatment at a temperature for a time sufficient for deactivating the pectin-decomposition enzyme or a cellulose-decomposition enzyme. Moreover, the thawing treatment in the foregoing step (1) may likewise be carried out simultaneous with the step of the enzyme-impregnation treatment under reduced pressure.

### TECHNICAL FIELD

The present invention relates to a method for preparing a soft vegetable material which is suitably used for the production of, in particular, a food or a meal for the aged persons and which maintains the shape of a particular ingredient of the food.

### BACKGROUND ART

It is in general difficult for the aged persons to have hard food materials. Moreover, the aged persons would have an intensive desire, like the usual persons, to enjoy the shapes and the colors of the ingredients included in the dishes supplied as a meal, in addition to the taste thereof when they take the same.

Under the present conditions, however, the meal for the aged persons is mainly in the form of pasty ones which have been cooked to such an extent that it is too soft to maintain the original shapes of the ingredients thereof or liquid-like ones, while paying special attention to the aged persons so that they can easily take the meal. Accordingly, it would be common that the aged persons cannot sufficiently enjoy the original shapes and colors of the ingredients of the meals and accordingly, to take a meal would be liable to become an unattractive affair for the aged persons. For this reason, the meals for the aged persons do not stimulate the appetite of these persons and accordingly, this may exert a harmful influence on the aged persons such that the strength of the body thereof gradually decline. Moreover, it would be quite difficult for the aged persons to sufficiently enjoy the color peculiar to each of the ingredients of dishes if the food materials are cooked or processed to such an extent that they are almost in the form of a pasty or liquid-like meal.

Moreover, it would be quite desirable for the aged persons to easily obtain hard food stuffs preliminarily softened on the market and to easily and personally cook or prepare their own meals at their own homes.

### DISCLOSURE OF THE INVENTION

Problems that the Invention is to Solve

There has recently been known a method for preparing a food stuff (see, for instance, Patent Document 1 specified below) which comprises the steps of freezing a raw or heat-treated food stuff and then thawing the frozen food stuff, immersing the food stuff in a dispersion of a pectin-decomposition enzyme under reduced pressure so that the decomposition enzyme permeates even into the central portion of the food stuff to accordingly make even the center thereof soft.

### Patent Document 1: JP-A-2003-284522.

It would be expected that this method for fast introduction of an enzyme into a food stuff, in which the enzyme can be introduced even into the central portion of the food stuff, permits the uniform treatments of such a food stuff such as the softening of not only the surface, but also the interior of the food stuff within a very short period of time.

However, the inventors of this invention have found that the fast enzyme-introduction method suffers from, for instance, the following problem: When a food stuff prepared according to this method is packed in a container without any further treatment, cold-stored and then put on the market, while it is maintained at the cold-storing condition, the food stuff inevitably undergoes gradual softening during its circulation or distribution process and accordingly, it becomes too soft, or even a hard food stuff such as a bamboo shoot or a carrot may be softened to such an extent that it is immediately disintegrated to thus lose its original shape thereof when it is to be cooked. On the other hand, it is also possible that a food stuff is packed in a container without any pre-treatment and then it is frozen, but the softening of the food stuff may still slightly or gradually be advanced. In addition, it is necessary to thaw the frozen food stuff prior to cooking and this accordingly takes the aged persons much time and this is also quite inconvenient for the aged persons.

For this reason, it would be quite convenient for the aged persons to cook, without any trouble, the food stuff whose softness is never advanced during storage and cooking and which maintains its softened state and its original shape and color and this is quite important for the aged persons to live in plenty.

### Means for the Solution of the Problems

The inventors of this invention have conducted intensive studies to provide a food stuff suitably used as the meal for the aged persons or a food stuff softened according to the foregoing method using an enzyme, which can maintain its desired softness even upon being put on the market, and which can maintain the shape, color and sufficient resistance to the teeth even when it is cooked without any pre-treatment immediately after purchasing the same, have found that a food stuff which can maintain its predetermined and desired hardness even after passing through the distribution channels and further after being stored in a household refrigerator can be prepared by softening a food stuff with an enzyme after once freezing the food stuff and then thawing the same, or during thawing the food stuff after once freezing the same; and subsequently subjecting the food stuff to a heat-treatment to thus completely deactivate the enzyme used in the preceding step, and have thus completed the present invention.

Accordingly, the present invention herein provides a method for preparing a soft vegetable (or plant) material or food stuff which is characterized in that it comprises the following steps:

(1) freezing a vegetable material and then thawing the same to thus prepare a thawed vegetable material;
(2) immersing the thawed vegetable material in a dispersion containing a pectin-decomposition enzyme or a cellulose-decomposition enzyme under reduced pressure; and
(3) subjecting the vegetable material, which has been immersed in the dispersion and then thawed, to a heat-treatment at a temperature for a time sufficient for deactivating the pectin-decomposition enzyme or a cellulose-decomposition enzyme.

In the meantime, the thawing treatment in the foregoing step (1) can be performed in the next step (2) for the treatment with the enzyme under reduced pressure. For this reason, the present invention according to another embodiment relates to a method for the preparation of a soft vegetable (or plant) material (or food stuff) which is characterized in that it comprises the following steps:

(1) freezing a vegetable material to give a frozen vegetable material;
(2) thawing the frozen vegetable material while immersing the vegetable material in a dispersion containing a pectin-decomposition enzyme or a cellulose-decomposition enzyme under reduced pressure to thus prepare a thawed vegetable material; and
(3) subjecting the vegetable material, which has been immersed in the dispersion and then thawed, to a heat-treatment at a temperature and for a time sufficient for deactivating the pectin-decomposition enzyme or a cellulose-decomposition enzyme present therein.

### BEST MODE FOR CARRYING OUT THE INVENTION

The present invention will hereunder be described in more detail.

The term “vegetable material” herein used means a vegetable (or plant) food stuff.

As such vegetable food stuffs suitably used in the present invention, there may be listed, for instance, vegetables such as carrots, Japanese radishes, onions and Chinese cabbages; potatoes such as white potato and sweet potato; cereals such as rice and wheat; beans such as soybeans and adzuki beans; fruits such as oranges and apples; bamboo shoots; arrowhead bulbs; and mushrooms such as shiitakes (Cortinellus shiitake).

It is preferred that raw or untreated vegetable materials are subjected to the removal of any dirt such as mud or the like and/or washed with, for instance, water prior to the freezing of the same. The vegetable material prior to the freezing thereof is not limited to raw materials and it may likewise be those subjected to a heat-treatment such as the blanching treatment.

Among the vegetable food stuffs, large ones are preferably cut into small pieces having a size of not more than 50 mm and preferably not more than 30 mm, in order to ensure the permeation of an enzyme into the interior of the food stuffs. Even the vegetable material having such a size can be used as a food stuff for the meal and can maintain its shape like the usual meal and one can thus enjoy the meal. In particular, the vegetable material can be used as a food stuff without any pre-treatment and for instance, beans can be subjected to the treatment according to the present invention and the resulting processed product can be used as food stuffs as such.

Subsequently, the vegetable material is frozen and then thawed. In this respect, the thawing treatment of the material may be carried out simultaneous with the next treatment with an enzyme.

The freezing treatment is in general carried out under such a condition that the vegetable material is completely frozen even in the inside thereof For instance, the temperature for freezing the vegetable material is not higher than −5° C., and preferably not higher than −15° C. The freezing treatment may be or may not be rapid one inasmuch as the freezing temperature is one sufficient for forming crystals of water within the vegetable material. In this respect, however, the freezing temperature is suitably −15° C. from the practical standpoint while taking into consideration the freezing time. Moreover, to make fine crystals of water uniformly distribute throughout the interior of the vegetable material, it is preferred to rapidly put the vegetable material into deepfreezing. Moreover, the slow or gradual freezing operation may result in the formation of relatively large cavities within the vegetable material. The freezing time may vary depending on the freezing temperature selected, but it in general ranges from about 20 to about 60 minutes when the freezing temperature is set at a level of −15° C. It is a matter of course that the vegetable material may be held at that freezing temperature for a time longer than that specified above.

The thawing operation is carried out by allowing the frozen vegetable material to stand at room temperature or by heating the material up to 50° C. and preferably up to 30° C. In this connection, it is preferred to carry out the thawing operation of the frozen vegetable material while immersing the material in a dispersion of an enzyme as will be detailed below, in particular, for the improvement of the thawing efficiency and the rate of the permeation of the enzyme into the material.

In the meantime, cold air is suitably blown on the surface of the frozen vegetable material to thus reduce the moisture present on the surface prior to the thawing of the frozen vegetable material since this operation may further improve the permeability of the enzyme into the material in the subsequent step. This is particularly preferred when the thawing operation is carried out simultaneous with the subsequent step (2) or the treatment with an enzyme under reduced pressure.

Suitably, the temperature of the cold air ranges, for instance, from −30 to 5° C. and preferably −20 to 0° C.

In addition, the cold air-drying time in general and suitably ranges from about 15 hours to about 3 days and preferably 1 to 2 days.

The thawing time is dependent upon the thawing temperature, but it is suitable that the thawing time in general ranges from 5 to 30 minutes and currently about 5 to about 15 minutes. In this connection, if the thawing operation is carried out in the subsequent step (2), the thawing time is in general identical to the time required for the treatment with an enzyme.

The vegetable material thus thawed is then immersed in a dispersion of a pectin-decomposition enzyme or a cellulose-decomposition enzyme under reduced pressure.

The immersion of the thawed vegetable material in the enzyme-containing dispersion under reduced pressure certainly permits the easy permeation of the enzyme into a large number of fine cavities or voids which are formed through the thawing of the fine crystals of water uniformly distributed within the frozen vegetable material. When the frozen vegetable material is thawed under reduced pressure, it is preferred to dry the surface of the frozen food in advance using cold air. In this respect, it would be recognized that the drying operation surely permits the easy replacement of the moisture present in the voids with the enzyme-containing dispersion when the fine crystals of water present in the interior of the frozen food undergoes sublimation under reduced pressure, since the surface of the frozen food has been dried in advance.

The higher the degree of the reduced pressure, the faster the permeation of the enzyme into the frozen food. However, it is suitable that the practical degree of the reduced pressure is set at a level of, for instance, not higher than 93 hPa (70 mmHg) and in general 13 to 80 hPa (10 to 60 mmHg), while taking into consideration the performance of the commercially available pressure-reducing device or a vacuum device. The pressure-reducing rate is not restricted to any specific level, but it is preferred to set it at a level ranging from 1 to 20 minutes, and preferably about 2 to about 10 minutes as expressed in terms of the time required for establishing a desired degree of vacuum.

The pressure-reducing time may vary depending on the magnitude of the reduced pressure and the pressure-reducing rate, but it is practical and sufficient to set it at a level ranging from, for instance, about 2 to about 5 minutes, in particular, about 2 to about 3 minutes.

Examples of enzymes used in the enzyme-containing dispersion include pectin-decomposition enzyme (pectinase) or a cellulose-decomposition enzyme (cellulase).

The pectin-decomposition enzyme is not restricted in its origin or the kinds of bacteria from which it is derived, insofar as it can undergo hydrolysis of pectin. Specific examples of commercially available pectin-decomposition enzymes favorably used in the present invention are Macerozyme 2A (having a pectinase content of 39%, available from Yakult Pharmaceutical Industry Co., Ltd.) and Pectoriase (having a pectinase content of 10%).

The cellulose-decomposition enzyme is not restricted in its origin or the kinds of bacteria from which it is derived, insofar as it can undergo hydrolysis of cellulose. Specific examples of commercially available cellulose-pectin-decomposition enzymes favorably used in the present invention include Macerozyme 2A (having a pectinase content of 39%, available from Yakult Pharmaceutical Industry Co., Ltd.).

The concentration of the enzyme-containing dispersion is not restricted to any specific level, but it is suitable that the concentration thereof in general ranges from 0.1 to 4.0% by mass and preferably 0.2 to 2.0% by mass. The medium of the dispersion is in general water, but a buffering agent (such as a citric acid salt or a phosphoric acid salt) may be incorporated into the medium for stably establishing or maintaining the optimum pH range for each specific enzyme.

It is suitable in the present invention to set the immersion temperature at a level, in general ranging from 10 to 50° C. and preferably 25 to 40° C. On the other hand, the immersion time may vary depending on the immersion temperature selected, but it is favorable in the invention to set it at a level, for instance, ranging from about 10 to about 80 minutes and preferably about 30 to about 60 minutes.

The vegetable material, in which the enzyme is permeated even into the interior thereof, is allowed to stand while immersing in the enzyme-containing dispersion until the softness of the vegetable material arrives at such a level which is fixed by the enzyme-deactivation treatment through heating as will be detailed below; or the vegetable material thus immersed in the enzyme-containing dispersion is allowed to stand after the removal thereof from the dispersion.

In this connection, it is preferred to allow the resulting food stuff, which has been subjected to the enzyme-immersion treatment for a predetermined time period at a relatively low temperature, for instance, room temperature (25° C.), to stand, after the completion of the enzyme-immersion treatment of the food stuff and the separation thereof from the enzyme-containing dispersion. This accordingly prevents the occurrence or advance of any further enzyme-decomposition of the surface thereof.

The softness (hardness) of the vegetable material greatly depends upon the time of the enzyme-immersion treatment under reduced pressure and the subsequent time of allowing the material to stand. It would be sufficient for the vegetable materials, which are relatively soft in themselves, such as beans and vegetables to subject them to an enzyme-immersion treatment for a short period of time, but the vegetable materials, which are relatively hard, such as a bamboo shoot and a carrot, are preferably subjected to an enzyme-immersion treatment for a relatively long period of time.

It is common and sufficient that the time required for the enzyme-immersion treatment ranges, for instance, from about 5 to about 40 minutes and preferably about 10 to about 30 minutes. The time required for the vacuum treatment can easily and reproducibly be determined if preliminarily examining the relation between the vacuum-treating time and the softness of the resulting food stuff and preparing a calibration curve for each kind of food stuff.

The enzyme-acting process or the step of allowing the vegetable material to stand after the enzyme-immersion treatment may be carried out in a predetermined atmosphere. This enzyme-acting time can be determined at a good reproducibility if preliminarily examining the relation between the enzyme-acting time and the hardness of a food stuff at a predetermined enzyme concentration and under the conditions to be used for each kind of the food stuff to thus prepare a calibration curve.

The foregoing predetermined atmosphere suitably used in the present invention is, for instance, one having a humidity ranging from 50 to 80% and maintained at room temperature (usually, 20 to 25° C.). In the meantime, the enzyme-acting process or the step of allowing the vegetable material to stand may likewise be carried out at a temperature which never adversely affects the enzyme, for instance, ranging from 35 to 50° C. and preferably 40 to 45° C. for the acceleration of the enzyme action.

Then, if the vegetable material is immersed in the enzyme-containing dispersion, the enzyme-containing dispersion is removed from the vegetable material subjected to the enzyme-immersion treatment and then the surface of the latter is washed with, for instance, water. Alternatively, the enzyme-treated food stuff may be introduced into a container for heating, immediately after the removal thereof from the enzyme-containing dispersion to thus deactivate the enzyme. The container for heating may be, for instance, a retort device or a simple container or pot containing high temperature water. In this respect, however, the retort device is herein listed simply as an example usable in the invention and it is in general used under its un-pressurized condition, but it can of course be used under the pressurized condition.

The thawed food stuff thus treated with an enzyme is then subjected to a heat-treatment at a high temperature for a long period of time sufficient for almost completely deactivating the enzyme used in the enzyme-treatment. Whether the enzyme is deactivated or not may easily be confirmed by those of ordinary skill in the art. For instance, a substrate can be incorporated into the enzyme-containing dispersion and then the resulting mixture can be inspected for the way how the substrate undergoes any change depending on the conditions such as the temperature and the treating time period to thus easily confirm whether the enzyme is deactivated or not.

The heating temperature used in this step suitably falls within the range of, for instance, from 70 to 100° C. and preferably 90 to 100° C.

The heating time for the step may vary depending on the deactivation temperature and it is sufficient that the heating time is set at a level ranging, for instance, from 5 to 20 minutes and preferably 10 to 20 minutes.

The hardness of the food stuff is fixed by this enzyme-deactivation treatment. At this stage, the resulting food stuff has the appearance almost identical to that observed for the raw or un-treated one. In other words, the food stuff thus treated shows almost the same shape and color observed for the usual food stuff free of any enzyme-treatment, except that the former is softened.

Accordingly, the aged persons can prepare, in their own house, a meal which suits their taste using such food stuff. In this connection, the hardness of the food stuff, which has been reduced by the enzyme-treatment, is in general further reduced through the cooking in each home such as the usual heat-treatment and therefore, the hardness of the food stuff should appropriately be adjusted in the enzyme-treatment while taking into consideration the degree of the softness of the food stuff observed when the food stuff is subjected to the foregoing usual heat-treatment.

The softness of food stuff which can easily be masticated by the aged persons using the tongue suitably ranges from 3000 to 10000 N/m² as expressed in terms of the value determined using a texturometer available from Takemoto Co., Ltd. In other words, the food stuff having a softness falling within the range specified above can easily be collapsed with the tongue and easily masticated.

In general, the hardness of food stuff is reduced by the cooking operation such as heating and/or well-boiling operations, but some of food stuffs never undergo their softness. The softness of the food stuff after the completion of the enzyme-treatment suitably ranges from about 20,000 to about 250,000 N/m² (2.0×10⁴ to 2.5×10⁵ N/m²) and preferably about 20,000 to about 200,000 N/m² (2.0×10⁴ to 2.5×10⁵ N/m²) as expressed in terms of the value determined using a texturometer available from Takemoto Co., Ltd.

Then the food stuff thus subjected to the enzyme-deactivation treatment is packaged in a container such as a packaging bag made of polyester, polypropylene, composite resin materials thereof, a laminated material thereof which comprise an aluminum foil inserted between the layers of the laminate or which is covered with an aluminum foil and then put on the market.

### EXAMPLES

The present invention will be described below in more detail with reference to the following Examples.

However, it is a matter of course that the scope of the present invention is not restricted to these specific Examples at all.

### Example 1

### Preparation of Cold-stored Food (Boiled Bamboo Shoot)

### Freezing Treatment of Bamboo Shoot

Canned bamboo shoot (the hardness of the bamboo shoot: 8.7×10⁵ N (determined using a texturometer available from Takemoto Co., Ltd.)) was taken out of the can, cut into uniform pieces having a size of 10×10×10 mm and then washed with water. Subsequently, the pieces were drained, frozen at a temperature of −19° C. and then allowed to stand under such conditions overnight (about 12 hours) to give a frozen food.

### Preparation of Enzyme-Containing Dispersion

Macerozyme 2A (having a pectinase content of 39%, available from Yakult Pharmaceutical Industry Co., Ltd.) was blended with and dispersed in water to thus form an enzyme-containing dispersion having an enzyme concentration of 0.3%.

Enzyme-Treatment under Reduced Pressure

The resulting frozen food was immersed in the enzyme-containing dispersion thus prepared and charged in a container placed within a pressure-reducing device (a vacuum device available from MISHIMA Food Co., Ltd.), the device was operated to reduce the pressure in the device and the pressure-reduction on the order of not higher than 93 hPa (70 mmHg) was maintained, in the device, at a temperature ranging from 20 to 25° C. for 20 minutes. In this connection, the permeation of the enzyme into the pieces and the thawing treatment thereof were carried out in parallel with the pressure-reducing operation. The resulting thawed food was removed from the pressure-reducing device, the food was allowed to stand in water maintained at 45° C. for about one hour followed by reducing the temperature of water down to room temperature and then allowing it to stand at room temperature for one hour to thus give a bamboo shoot food product subjected to the enzyme-impregnation treatment.

Hardness of Bamboo Shoot after Enzyme-Impregnation Treatment

The bamboo shoot food product obtained after the enzyme-impregnation treatment was inspected for the hardness using a texturometer available from Takemoto Co., Ltd. and it was found to be 2.6×10⁵ N/m².

### Heat-Treatment

The resulting bamboo shoot food product subjected to the enzyme-impregnation treatment was heated at a temperature ranging from 85 to 90° C. for 10 minutes to thus deactivate the enzyme present therein.

### Cold-Storing Treatment

After the deactivation treatment, the food product was allowed to stand while refrigerating the same at 10° C. overnight (about 12 hours) to thus give an enzyme-treated and refrigerated food product.

### Seasoning Treatment

The resulting cold-stored food product was immersed in a 1.1% aqueous solution of common salt and heated for 35 minutes to thus season the food product.

Hardness of Bamboo Shoot after Seasoning Treatment

The bamboo shoot food product obtained after the seasoning treatment was inspected for the hardness using a texturometer available from Takemoto Co., Ltd. and it was found to be 1.7×10⁵ N/m².

The seasoned bamboo shoot surely maintained the original shape thereof, but it could easily be crumbled up with the tongue upon keeping it in the mouth and could easily be swallowed.

### Comparative Example 1

Canned bamboo shoot (the hardness of the bamboo shoot: 8.7×10⁵ N (determined using a texturometer available from Takemoto Co., Ltd.)) was taken out of the can, cut into uniform pieces having a size of 10×10×10 mm and then washed with water. Subsequently, the pieces were immersed in a 1.1% aqueous solution of common salt and heated for 35 minutes to thus season the food product. The bamboo shoot food product obtained after the seasoning treatment was inspected for the hardness using a texturometer available from Takemoto Co., Ltd. and it was found to be 7.5×10⁵ N/m².

The bamboo shoot food product obtained in this Comparative Example 1 was too hard to easily crumble the same with the tongue and it could not be collapsed without the help of the teeth.

### Example 2

### Preparation of Cold-stored Food (Cooked Burdock)

### Pre-boiling Treatment of Burdock

Raw burdock (having a hardness of 2.7×10⁶ N/M² (determined using a texturometer available from Takemoto Co., Ltd.) was subjected to peeling, cut into round slices each having a height of 10 mm and then washed with water. The slices were then subjected to a pre-boiling treatment at 95° C. for 5 minutes, cooled with water and then drained.

Hardness of Burdock after Pre-boiling Treatment

The burdock obtained after the pre-boiling treatment was inspected for the hardness using a texturometer available from Takemoto Co., Ltd. and it was found to be 2.3×10⁶ N/M².

### Freezing Treatment of Burdock

The round slices of burdock were frozen at a temperature of −19° C. and then allowed to stand under such conditions overnight (about 12 hours) to give a frozen food.

### Preparation of Enzyme-Containing Dispersion

Macerozyme 2A (having a pectinase content of 39%, available from Yakult Pharmaceutical Industry Co., Ltd.) was blended with and dispersed in water to thus form an enzyme-containing dispersion having an enzyme concentration of 0.3%.

Enzyme-Treatment under Reduced Pressure

The resulting frozen food was immersed in the enzyme-containing dispersion thus prepared and charged in a container placed within a pressure-reducing device (a vacuum device available from MISHIMA Food Co., Ltd.), the device was operated to reduce the pressure in the device and the pressure-reduction on the order of not higher than 93 hPa (70 mmHg) was maintained, in the device, at a temperature ranging from 20 to 25° C. for 20 minutes. In this connection, the permeation of the enzyme into the round slices and the thawing treatment thereof were carried out in parallel with the pressure-reducing operation. The resulting thawed food was withdrawn from the pressure-reducing device, the food was allowed to stand in water maintained at 45° C. for about one hour followed by reducing the temperature of water down to room temperature and then allowing it to stand in the water at room temperature for one hour to thus give an enzyme impregnation-treated burdock food product.

Hardness of Burdock Food Product after Enzyme-Impregnation Treatment

The burdock food product obtained after the enzyme-impregnation treatment was inspected for the hardness using a texturometer available from Takemoto Co., Ltd. and it was found to be 2.5×10⁵ N/m².

### Heat-Treatment

The resulting burdock food product subjected to the enzyme-impregnation treatment was heated at a temperature ranging from 85 to 90° C. for 10 minutes to thus deactivate the enzyme present therein.

### Cold-storing Treatment

After the enzyme-deactivation treatment, the food product was allowed to stand while cold-storing the same at 10° C. overnight (about 12 hours) to thus give an enzyme-treated and cold-stored food product.

### Seasoning Treatment

The resulting thawed food product was immersed in a 1.1% aqueous solution of common salt and heated for 35 minutes to thus season the food product.

Hardness of Burdock after Seasoning Treatment

The burdock food product obtained after the seasoning treatment was inspected for the hardness using a texturometer available from Takemoto Co., Ltd. and it was found to be 2.0×10⁵ N/m².

The seasoned burdock food product surely maintained the original shape thereof, but it could easily be crumbled up with the tongue and could easily be swallowed.

### Comparative Example 2

Raw burdock (having a hardness of 2.7×10⁶ N/M² (as determined using a texturometer available from Takemoto Co., Ltd.) was subjected to peeling, cut into round slices each having a height of 10 mm and then washed with water. The slices were then subjected to a pre-boiling treatment at 95° C. for 5 minutes, cooled with water and then drained. The burdock round slices obtained after the pre-boiling treatment were inspected for the hardness using a texturometer available from Takemoto Co., Ltd. and it was found to be 2.3×10⁶ N/M². Subsequently, the slices were immersed in a 1.1% aqueous solution of common salt and heated for 35 minutes to thus season the food product. The burdock food product obtained after the seasoning treatment was inspected for the hardness using a texturometer available from Takemoto Co., Ltd. and it was found to be 1.4×10⁶ N/M².

The burdock food product obtained in this Comparative Example 2 was too hard to easily crumble the same with the tongue and it could not be collapsed without the help of the teeth.

### Example 3

### Preparation of Cold-stored Food (Cooked Lotus Root)

### Pre-boiling Treatment of Burdock

A raw lotus root (having a hardness of 2.7×10⁶ N as determined by the use of a texturometer available from Takemoto Co., Ltd.) was subjected to peeling, cut into uniform pieces having a size of 10×10×10 mm and then washed with water. The pieces were then subjected to a pre-boiling treatment at 95° C. for 5 minutes, cooled with water and then drained.

Hardness of Lotus Root after Pre-boiling Treatment

The lotus root obtained after the pre-boiling treatment was inspected for the hardness using a texturometer available from Takemoto Co., Ltd. and it was found to be 2.3×10⁶ N/m².

### Freezing Treatment of Lotus Root

The pieces of lotus root were frozen at a temperature of −19° C. and then allowed to stand under such conditions overnight (about 12 hours) to give a frozen food.

### Preparation of Enzyme-Containing Dispersion

Macerozyme 2A (having a pectinase content of 39%, available from Yakult Pharmaceutical Industry Co., Ltd.) was blended with and dispersed in water to thus form an enzyme-containing dispersion having an enzyme concentration of 1.0%.

Enzyme-Treatment under Reduced Pressure

The resulting frozen food was immersed in the enzyme-containing dispersion thus prepared and charged in a container placed within a pressure-reducing device (a vacuum device available from MISHIMA Food Co., Ltd.), the device was operated to reduce the pressure in the device and the pressure-reduction on the order of not higher than 93 hPa (70 mmHg) was maintained, in the device, at a temperature ranging from 20 to 25° C. for 20 minutes. In this connection, the permeation of the enzyme into the pieces and the thawing treatment thereof were carried out in parallel with the pressure-reducing operation. The resulting thawed food was withdrawn from the pressure-reducing device, the food was allowed to stand in water maintained at 45° C. for about one hour, followed by reducing the temperature of water down to room temperature and then allowing it to stand in the water at room temperature for one hour to thus give an enzyme impregnation-treated lotus root food product.

Hardness of Lotus Root Food Product after Enzyme-Impregnation Treatment

The lotus root food product obtained after the enzyme-impregnation treatment was inspected for the hardness using a texturometer available from Takemoto Co., Ltd. and it was found to be 2.0×10⁵ N/m².

### Heat-Treatment

The resulting lotus root food product subjected to the enzyme-impregnation treatment was heated at a temperature ranging from 85 to 90° C. for 10 minutes to thus deactivate the enzyme present therein.

### Cold-storing Treatment

After the enzyme-deactivation treatment, the food product was allowed to stand while cold-storing the same at 10° C. overnight (about 12 hours) to thus give an enzyme-treated and refrigerated food product.

### Seasoning Treatment

The resulting thawed food product was immersed in a 1.1% aqueous solution of common salt and heated for 35 minutes to thus season the food product.

Hardness of Lotus Root after Seasoning Treatment

The lotus root food product obtained after the seasoning treatment was inspected for the hardness using a texturometer available from Takemoto Co., Ltd. and it was found to be 1.9×10⁵ N/m².

The seasoned lotus root food product surely maintained the original shape thereof, but it could easily be crumbled up with the tongue in the mouth and could easily be swallowed.

### Comparative Example 3

Raw lotus root (having a hardness of 2.7×10⁶ N/m² (as determined using a texturometer available from Takemoto Co., Ltd.) was subjected to peeling, cut into uniform pieces having a size of 10×10×10 mm and then washed with water. The pieces were then subjected to a pre-boiling treatment at 95° C. for 5 minutes, cooled with water and then drained.

The pieces of lotus root obtained after the pre-boiling treatment were inspected for the hardness using a texturometer available from Takemoto Co., Ltd. and it was found to be 2.3×10⁶ N/m². Subsequently, the pieces were immersed in a 1.1% aqueous solution of common salt and heated for 35 minutes to thus season the food product. The lotus root food product obtained after the seasoning treatment was inspected for the hardness using a texturometer available from Takemoto Co., Ltd. and it was found to be 1.7×10⁶ N/m².

The lotus root food product obtained in this Comparative Example 3 was too hard to easily crumble the same with the tongue and it could not be collapsed without the help of the teeth.

### Example 4

### Preparation of Frozen Food (Cooked Bamboo Shoot)

### Freezing Treatment of Bamboo Shoot

Canned bamboo shoot (the hardness of the bamboo shoot: 8.7×10⁵ N (determined using a texturometer available from Takemoto Co., Ltd.)) was taken out of the can, cut into uniform pieces having a size of 10×10×10 mm and then washed with water. Subsequently, the pieces were drained, frozen at a temperature of −19° C. and then allowed to stand under such conditions overnight (about 12 hours) to give a frozen food.

### Preparation of Enzyme-Containing Dispersion

Macerozyme 2A (having a pectinase content of 39%, available from Yakult Pharmaceutical Industry Co., Ltd.) was blended with and dispersed in water to thus form an enzyme-containing dispersion having an enzyme concentration of 0.3%.

Enzyme-Treatment under Reduced Pressure

The resulting frozen food was immersed in the enzyme-containing dispersion thus prepared and introduced into a container placed within a pressure-reducing device (a vacuum device available from MISHIMA Food Co., Ltd.), the device was operated to reduce the pressure in the device and the pressure-reduction on the order of not higher than 93 hPa (70 mmHg) was maintained, in the device, at a temperature ranging from 20 to 25° C. for 20 minutes. In this connection, the permeation of the enzyme into the pieces and the thawing treatment thereof were carried out in parallel with the pressure-reducing operation. The resulting thawed food was withdrawn from the pressure-reducing device, the food was allowed to stand in water maintained at 45° C. for about one hour, followed by reducing the temperature of water down to room temperature and then allowing it to stand at room temperature for one hour to thus give a bamboo shoot food product subjected to the enzyme-impregnation treatment.

Hardness of Bamboo Shoot after Enzyme-Impregnation Treatment

The bamboo shoot food product obtained after the enzyme-impregnation treatment was inspected for the hardness using a texturometer available from Takemoto Co., Ltd. and it was found to be 2.6×10⁵ N/m².

The seasoned bamboo shoot surely maintained the original shape thereof, but it could easily be crumbled up with the tongue in the mouth and could easily be swallowed.

### Heat-Treatment

The resulting bamboo shoot food product subjected to the enzyme-impregnation treatment was heated at a temperature ranging from 85 to 90° C. for 10 minutes to thus deactivate the enzyme present therein.

### Freezing Treatment

After the deactivation treatment, the food product was allowed to stand while freezing the same at a temperature of −19° C. overnight (about 12 hours) to thus give an enzyme-treated and frozen food product.

### Thawing Treatment

The resulting enzyme-treated and frozen food product was thawed at a temperature of not higher than 10° C. overnight (about 12 hours).

Hardness of Bamboo Shoot after Thawing Treatment

The bamboo shoot food product obtained after the thawing treatment was inspected for the hardness using a texturometer available from Takemoto Co., Ltd. and it was found to be 2.2×10⁵ N/m².

### Seasoning Treatment

The resulting thawed food product was immersed in a 1.1% aqueous solution of common salt and heated for 35 minutes to thus season the food product.

Hardness of Bamboo Shoot after Seasoning Treatment

The bamboo shoot food product obtained after the seasoning treatment was inspected for the hardness using a texturometer available from Takemoto Co., Ltd. and it was found to be 1.5×10⁵ N/m².

The seasoned bamboo shoot surely maintained the original shape thereof, but it could easily be crumbled up with the tongue in the mouth and could easily be swallowed.

### Comparative Example 4

Canned bamboo shoot (the hardness of the bamboo shoot: 8.7×10⁵ N (determined using a texturometer available from Takemoto Co., Ltd.)) was taken out of the can, cut into uniform pieces having a size of 10×10×10 mm and then washed with water. Subsequently, the pieces were immersed in a 1.1% aqueous solution of common salt and heated for 35 minutes to thus season the food product. The bamboo shoot food product obtained after the seasoning treatment was inspected for the hardness using a texturometer available from Takemoto Co., Ltd. and it was found to be 7.5×10⁵ N/m².

The bamboo shoot food product obtained in this Comparative Example 4 was too hard to easily crumble the same with the tongue and it could not be collapsed without the help of the teeth.

### Example 5

### Preparation of Frozen Food (Cooked Burdock)

### Pre-boiling Treatment of Burdock

Raw burdock (having a hardness of 2.7×10⁶ N/m² (determined using a texturometer available from Takemoto Co., Ltd.) was subjected to peeling, cut into round slices each having a height of 10 mm and then washed with water. The slices were then subjected to a pre-boiling treatment at 95° C. for 5 minutes, cooled with water and then drained.

Hardness of Burdock after Pre-boiling Treatment

The burdock obtained after the pre-boiling treatment was inspected for the hardness using a texturometer available from Takemoto Co., Ltd. and it was found to be 2.3×10⁶ N/m².

### Freezing Treatment of Burdock

The round slices of burdock were frozen at a temperature of −19° C. and then allowed to stand under such conditions overnight (about 12 hours) to give a frozen food.

### Preparation of Enzyme-Containing Dispersion

Macerozyme 2A (having a pectinase content of 39%, available from Yakult Pharmaceutical Industry Co., Ltd.) was blended with and dispersed in water to thus form an enzyme-containing dispersion having an enzyme concentration of 0.3%.

Enzyme-Treatment under Reduced Pressure

The resulting frozen food was immersed in the enzyme-containing dispersion thus prepared and introduced into a container placed within a pressure-reducing device (a vacuum device available from MISHIMA Food Co., Ltd.), the device was operated to reduce the pressure in the device and the pressure-reduced state at a pressure on the order of not higher than 93 hPa (70 mmHg) was maintained, in the device, at a temperature ranging from 20 to 25° C. for 20 minutes. In this connection, the permeation of the enzyme into the round slices and the thawing treatment thereof were carried out in parallel with the pressure-reducing operation. The resulting thawed food was withdrawn from the pressure-reducing device, the food was allowed to stand in water maintained at 45° C. for about one hour, followed by the reduction of the water temperature down to room temperature and then allowing it to stand in the water at room temperature for one hour to thus give an enzyme impregnation-treated burdock food product.

Hardness of Burdock Food Product after Enzyme-Impregnation Treatment

The burdock food product obtained after the enzyme-impregnation treatment was inspected for the hardness using a texturometer available from Takemoto Co., Ltd. and it was found to be 2.5×10⁵ N/m².

### Heat-Treatment

The resulting burdock food product subjected to the enzyme-impregnation treatment was heated at a temperature ranging from 85 to 90° C. for 10 minutes to thus deactivate the enzyme present therein.

### Freezing Treatment

After the enzyme-deactivation treatment, the food product was allowed to stand while freezing the same at a temperature of −19° C. overnight (about 12 hours) to thus give an enzyme-treated and frozen food product.

### Thawing Treatment

The resulting enzyme-treated and frozen food product was thawed at a temperature of not higher than 10° C. overnight (about 12 hours).

Hardness of Burdock Food Product after Thawing Treatment

The burdock food product obtained after the thawing treatment was inspected for the hardness using a texturometer available from Takemoto Co., Ltd. and it was found to be 2.0×10⁵ N/m².

### Seasoning Treatment

The resulting thawed food product was immersed in a 1.1% aqueous solution of common salt and heated for 35 minutes to thus season the food product.

Hardness of Burdock Food Product after Seasoning Treatment

The burdock food product obtained after the seasoning treatment was inspected for the hardness using a texturometer available from Takemoto Co., Ltd. and it was found to be 1.2×10⁵ N/m².

The seasoned burdock food product surely maintained the original shape thereof, but it could easily be crumbled up with the tongue in the mouth and could easily be swallowed.

### Comparative Example 5

Raw burdock (having a hardness of 2.7×10⁶ N/M² (as determined using a texturometer available from Takemoto Co., Ltd.) was subjected to peeling, cut into round slices each having a height of 10 mm and then washed with water. The slices were then subjected to a pre-boiling treatment at 95° C. for 5 minutes, cooled with water and then drained. The burdock round slices obtained after the pre-boiling treatment were inspected for the hardness using a texturometer available from Takemoto Co., Ltd. and it was found to be 2.3×10⁶ N/M². Subsequently, the slices were immersed in a 1.1% aqueous solution of common salt and heated for 35 minutes to thus season the food product. The burdock food product obtained after the seasoning treatment was inspected for the hardness using a texturometer available from Takemoto Co., Ltd. and it was found to be 1.4×10⁶ N/m².

The burdock food product obtained in this Comparative Example 5 was too hard to easily crumble the same with the tongue and it could not be collapsed without the help of the teeth.

### Example 6

### Preparation of Frozen Food (Cooked Lotus Root)

### Pre-boiling Treatment of Burdock

A raw lotus root (having a hardness of 2.7×10⁶ N as determined by the use of a texturometer available from Takemoto Co., Ltd.) was subjected to peeling, cut into uniform pieces having a size of 10×10×10 mm and then washed with water. The pieces were then subjected to a pre-boiling treatment at 95° C. for 5 minutes, cooled with water and then drained.

Hardness of Lotus Root after Pre-boiling Treatment

The lotus root obtained after the pre-boiling treatment was inspected for the hardness using a texturometer available from Takemoto Co., Ltd. and it was found to be 2.3×10⁶ N/m².

### Freezing Treatment of Lotus Root

The pieces of lotus root were frozen at a temperature of −19° C. and then allowed to stand under such conditions overnight (about 12 hours) to give a frozen food.

### Preparation of Enzyme-Containing Dispersion

Macerozyme 2A (having a pectinase content of 39%, available from Yakult Pharmaceutical Industry Co., Ltd.) was blended with and dispersed in water to thus form an enzyme-containing dispersion having an enzyme concentration of 1.0%.

Enzyme-Treatment under Reduced Pressure

The resulting frozen food was immersed in the enzyme-containing dispersion thus prepared and introduced into a container placed within a pressure-reducing device (a vacuum device available from MISHIMA Food Co., Ltd.), the device was operated to reduce the pressure in the device and the device was maintained at a reduced pressure on the order of not higher than 93 hPa (70 mmHg) at a temperature ranging from 20 to 25° C. for 20 minutes. In this connection, the permeation of the enzyme into the pieces and the thawing treatment thereof were carried out in parallel with the pressure-reducing operation. The resulting thawed food was withdrawn from the pressure-reducing device, the food was allowed to stand in water maintained at 45° C. for about one hour, followed by the reduction of the water temperature down to room temperature and then allowing it to stand in the water at that temperature for one hour to thus give an enzyme impregnation-treated lotus root food product.

Hardness of Lotus Root Food Product after Enzyme-Impregnation Treatment

The lotus root food product obtained after the enzyme-impregnation treatment was inspected for the hardness using a texturometer available from Takemoto Co., Ltd. and it was found to be 2.0×10⁵ N/m².

### Heat-Treatment

The resulting lotus root food product subjected to the enzyme-impregnation treatment was heated at a temperature ranging from 85 to 90° C. for 10 minutes to thus deactivate the enzyme present therein.

### Freezing Treatment

After the enzyme-deactivation treatment, the food product was allowed to stand while freezing the same at −19° C. overnight (about 12 hours) to thus give an enzyme-treated and frozen food product.

### Thawing Treatment

The resulting enzyme-treated and frozen food product was thawed at a temperature of not higher than 10° C. overnight (about 12 hours).

Hardness of Lotus Root Food Product after Thawing Treatment

The lotus root food product obtained after the thawing treatment was inspected for the hardness using a texturometer available from Takemoto Co., Ltd. and it was found to be 1.7×10⁵ N/m².

### Seasoning Treatment

The resulting thawed food product was immersed in a 1.1% aqueous solution of common salt and heated for 35 minutes to thus season the food product.

Hardness of Lotus Root after Seasoning Treatment

The lotus root food product obtained after the seasoning treatment was inspected for the hardness using a texturometer available from Takemoto Co., Ltd. and it was found to be 1.6×10⁵ N/m².

The seasoned lotus root food product surely maintained the original shape thereof, but it could easily be crumbled up with the tongue in the mouth and could easily be swallowed.

### Comparative Example 6

Raw lotus root (having a hardness of 2.7×10⁶ N/M² (as determined using a texturometer available from Takemoto Co., Ltd.) was subjected to peeling, cut into uniform pieces having a size of 10×10×10 mm and then washed with water. The pieces were then subjected to a pre-boiling treatment at 95° C. for 5 minutes, cooled with water and then drained.

The pieces of lotus root obtained after the pre-boiling treatment were inspected for the hardness using a texturometer available from Takemoto Co., Ltd. and it was found to be 2.3×10⁶ N/m². Subsequently, the pieces were immersed in a 1.1% aqueous solution of common salt and heated for 35 minutes to thus season the food product. The lotus root food product obtained after the seasoning treatment was inspected for the hardness using a texturometer available from Takemoto Co., Ltd. and it was found to be 1.7×10⁶ N/m².

The lotus root food product obtained in this Comparative Example 6 was too hard to easily crumble the same with the tongue and it could not be collapsed without the help of the teeth.

What is claimed is:

1. A method for preparing a soft vegetable material, comprising the steps of:
(1) freezing a vegetable material and then thawing the frozen vegetable material to thus form a thawed vegetable material;
(2) immersing the thawed vegetable material in a dispersion containing a pectin-decomposition enzyme or a cellulose-decomposition enzyme under reduced pressure; and
(3) subjecting the resultant immersed, thawed vegetable material to a heat-treatment at a temperature for a time sufficient for deactivating the pectin-decomposition enzyme or a cellulose-decomposition enzyme.

2. A soft vegetable material prepared according to the method as set forth in claim 1.

3. A method for preparing a soft vegetable material, comprising the steps of:
(1) freezing a vegetable material to give a frozen vegetable material;
(2) thawing the frozen vegetable material while immersing the vegetable material in a dispersion containing a pectin-decomposition enzyme or a cellulose-decomposition enzyme under reduced pressure to thus prepare a thawed vegetable material; and
(3) subjecting the resultant immersed, thawed vegetable material to a heat-treatment at a temperature for a time sufficient for deactivating the pectin-decomposition enzyme or a cellulose-decomposition enzyme.

4. A soft vegetable material prepared according to the method as set forth in claim 3.
